(19) United States
(12) Patent Application Publication
(10) Pub. No.: US 2006/0087506 A1
(43) Pub. Date: Apr. 27, 2006

(54) Three-dimensional design supporting program and three dimensional design supporting apparatus

(75) Inventors: Kazuhiro Takeuchi, Shizuoka (JP); Masahiro Nagakura, Shizuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/297,521

(22) Filed: Dec. 9, 2005

Related U.S. Application Data
(63) Continuation of application No. PCT/JP03/07363, filed on Jun. 10, 2003.

(51) Int. Cl. G06T 15/00

(52) U.S. Cl. 345/419; 700/98

(57) ABSTRACT

A three-dimensional design assisting program in which sheet information is set at the time of editing three-dimensional shape information defining a three-dimensional shape while dividing and that three-dimensional shape is divided. Partial areas can be obtained by dividing the three-dimensional shape by the sheet information without having any effect on shape information defining the three-dimensional shape.

### CROSS-REFERENCE TO RELATED APPLICATION

This is a continuation of Application PCT/JP2003/007363, filed on Jun. 10, 2003, now pending, the contents of which are herein wholly incorporated by reference.

### BACKGROUND OF THE INVENTION

1. Technical Field

The present invention relates to a design supporting technology for a three dimensional design shape, which is a so-called three dimensional CAD (Computer Aided Design).

2. Background Arts

CAD (Computer Aided Design) has hitherto been widely utilized as a technology for supporting design of architectural structures or a variety of industrial products by a computer. Drawing data of a product created by the CAD is translated into data for a computer in a product manufacturing/assembling line in the process of manufacturing the product. Then, CAM (Computer Aided Manufacturing) is actualized by the translated data of the product. The CAD includes so-called two dimensional CAD, wherein a shape of the product to be designed is represented in a planar shape as by a freehand drawing that has hitherto been used. Further, the CAD also includes so-called three dimensional CAD, wherein the product is represented three-dimensionally by representing a depth of the shape of the product to be designed.

Complicated shapes are represented by designing the architectural structures or the variety of industrial products in a way that utilizes the three dimensional CAD, and these shapes can be actualized as the products.

By the way, a generally conducted method is a method of adding, to the drawing data, other-than-shape information of the product as additional information such as pieces of information of a surface finishing attribute etc. on the shape and an on-production processing method instructed about the attribute in this type of three dimensional CAD.

In the case of defining plural items of additional information to a segmental area of the shape, edge lines and points are newly generated on the drawing at a boundary of a definition object portion, and the surface and the edge line are each segmented. On this premise, the additional information is defined for the post-segmentation surfaces and the post-segmentation edge lines.

FIG. 1 is a diagram showing one example of the method of defining the additional information to the three dimensional shape in the conventional method described above. FIG. 1 illustrates a case of defining a finishing symbol a and a finishing symbol b that are different from each other with respect to a segmental area of a surface 1 of a three dimensional cylindrical shape 200 with a boundary indicated by a broken line 201. At this time, a solid line 202 is generated along the surface 1 of the three dimensional shape 200. Then, with this solid line 202 serving as a boundary, the surface 1 is segmented into segmental areas such as a surface 1-1 and a surface 1-2. Through this procedure, according to the conventional design method, attribute information (additional information) referred to as the finishing symbol a and the finishing symbol b is defined for the segmented surfaces 1-1 and 1-2, respectively. Note that technologies (refer to, e.g., Patent documents 1 and Patent document 2) related to an information processing device capable of facilitating views of both of a 3D model and the attribute information and effectively utilizing the attribute information even when attaching the attribute information such as dimensions and a dimensional tolerance to the 3 D model generated by use of a CAD system, are disclosed as the technologies related to the processing of the attribute information of the graphic form in the CAD.

In the case of defining plural items of additional information to the segmental area of the three dimensional shape by the conventional additional information defining method described above, there arise, for instance, the following problems.

At first, in the additional information defining method shown in FIG. 1, as to the surface and the edge line about which the additional information is defined, an unnecessary edge line and an unnecessary point are generated. Then, the original surface and the original edge line are segmented by the unnecessary edge line and the unnecessary point. Therefore, the aforementioned defining method has difficulty in terms of acquiring various categories of data based on the shape, such as becoming complicated of calculation of an area size in the case of calculating the area size of the surface about which plural items of additional information are defined.

Moreover, according to the defining method described above, because of segmenting the surface itself about which the plural items of additional information are defined, the design for each of the segmented surfaces should be changed individually if a change in design of the shape occurs.

FIG. 2 is a view showing one example of this problem. In FIG. 2, a three dimensional shape 300 is segmented by an edge line 303 for segmenting the surface into segmental areas, i.e., a surface 301 and a surface 302. Then, in this case, the surface 301 and the surface 302 are respectively defined as separate surfaces by the edge line 303 in terms of data. Therefore, in the case of moving positions of the surface 301 and the surface 302, the surface 301 and the surface 302 must be individually moved, resulting in a complicated operation.

Further, the technologies in Patent document 1 and Patent document 2 are related to methods of displaying the attribute information such as dimensions but do not solve the problem pertaining to the additional information in the prior art.

Patent Document 1

Japanese Patent Application Laid-Open Publication No. 2002-324091

Patent Document 2

Japanese Patent Application Laid-Open Publication No. 2002-324253

### SUMMARY OF THE INVENTION

The present invention was devised in view of the problems inherent in those conventional technologies. Namely, it is an object of the present invention to provide a technology capable of defining, without exerting influence on shape information that defines a three dimensional shape, a segmental area on the three dimensional shape and further of setting attributes to this segmental area.

The present invention adopts the following means in order to solve the problems.

Namely, according to the present invention, three dimensional shape information that defines a three dimensional shape containing one or more surfaces, is edited, and sheet information of a three dimensional sheet intersecting the three dimensional shape and segmenting any one of the surfaces into a segmental area(s), is set.

In the present invention, on the occasion of editing the three dimensional shape information defining the three dimensional shape in a way that segments the three dimensional shape, the sheet information is set, and this three dimensional shape is segmented. Hence, according to the present invention, the segmented-by-the-sheet-information area can be set as the segmental area without affecting the shape information that defines the three dimensional shape.

Further, in the present invention, the sheet information may be stored independently of the three dimensional shape information. The term “independently” given herein connotes that the three dimensional shape information does not undergo any change in shape due to storing the sheet information.

Moreover, in the present invention, attribute information other than the information about the shape may be attached to the segmental area. Therefore, according to the present invention, the different attribute information can be defined for each of the segmental areas into which the three dimensional shape is segmented.

Still further, in the present invention, the attribute information may be stored independently of the three dimensional shape information, and there may be stored information that associates the attribute information, the sheet information and the three dimensional shape information with each other.

Hence, according to the present invention, after storing the attribution information and the three dimensional shape information independently, the three dimensional shape is segmented by the sheet information into the segmental areas, and the attribution information can be attached to each segmental area.

Yet further, in the present invention, a computer may be made to execute a step of defining a three dimensional graphic form and storing information that defines the three dimensional graphic form in accordance with an operation of an operator, a step of storing information that defines a sheet as a surface defined independently of the three dimensional graphic form in accordance with the operation of the operator in a way that associates this sheet defining information with a surface(s) shaping the three dimensional graphic form, a step of generating and storing information defining a segmental area of the surface shaping the three dimensional graphic form on the basis of the information defining the three dimensional graphic form and the information defining the sheet, and a step of regenerating and storing, as a trigger of a change in the information of the three dimensional graphic form or in the information of the sheet, the information defining the segmental area on the basis of the information after being changed.

On the occasion of editing the three dimensional graphic form information defining the three dimensional graphic form in a way that segments the three dimensional graphic form, the formation that defines the sheet is set, and this three dimensional graphic form is segmented. Hence, according to the present invention, the segmented-by-the-sheet-defining-information area can be set as the segmental area without affecting the information that defines the three dimensional graphic form.

It should be noted that the present invention may also be a program having any one of the above functions actualized. Further, the present invention may also be a readable-by-computer storage medium stored with such a program. Moreover, the present invention may also be a device that actualizes any one of the above functions.

### BRIEF DESCRIPTION OF THE DRAWINGS

FIG. 1 is a diagram showing one example of a method of defining additional information to a three dimensional shape in a conventional method;

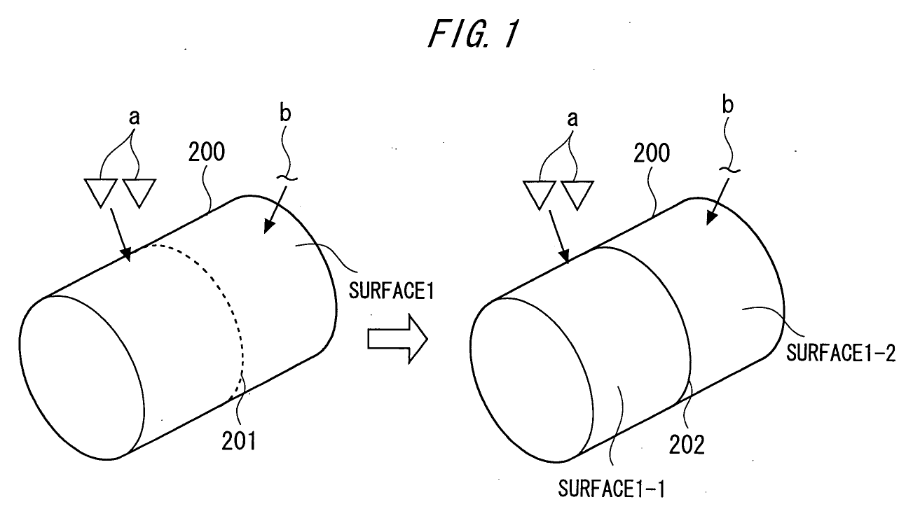

FIG. 2 is a view showing one example of a problem of the prior art;

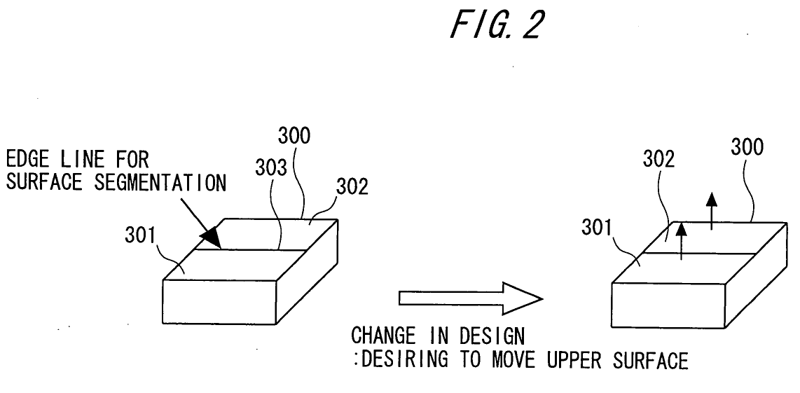

FIG. 3 is a view illustrating a concept of a segmental area in the present design supporting system;

FIG. 4A-4C are views showing a definition example of the segmental area;

FIG. 5 is a view showing a definition and an operation of an area definition sheet based on an absolute value definition (absolute coordinate system);

FIG. 6 is a view showing a definition and an operation of the area definition sheet based on a relative value definition (relative coordinate system);

FIG. 7 is a view of a system architecture of the present design supporting system;

FIG. 8 is a diagram showing relationships between data structures of various categories of data and these items of data when defining the segmental area;

FIG. 9 is a flowchart showing a processing sequence when defining the segmental area; and

FIG. 10 is a flowchart showing a recalculation process of the segmental area when editing a shape.

### DETAILED DESCRIPTION OF THE INVENTION

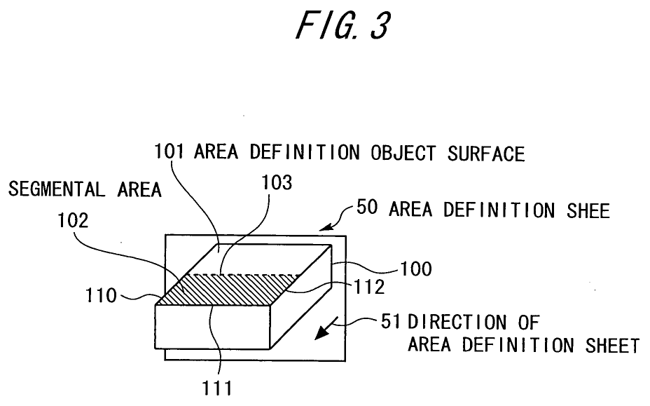

A design supporting system according to a best mode of the present invention will hereinafter be described with reference to the drawings in FIGS. 3 through 10.

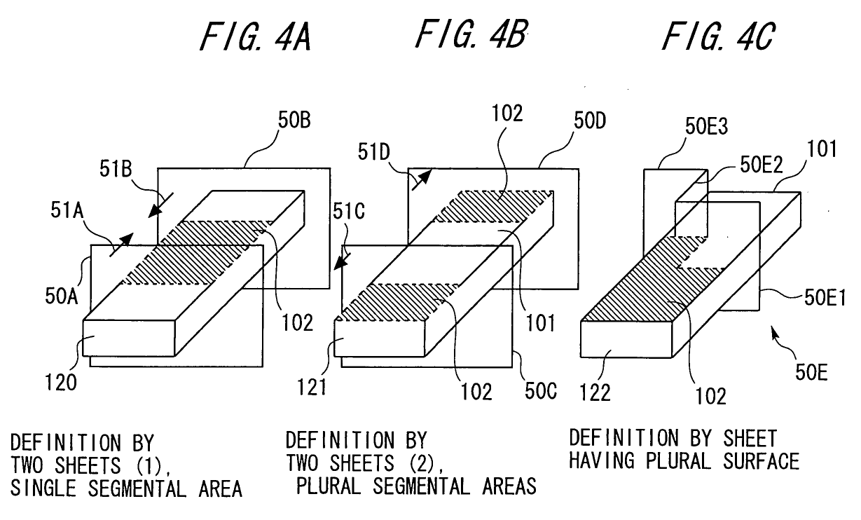

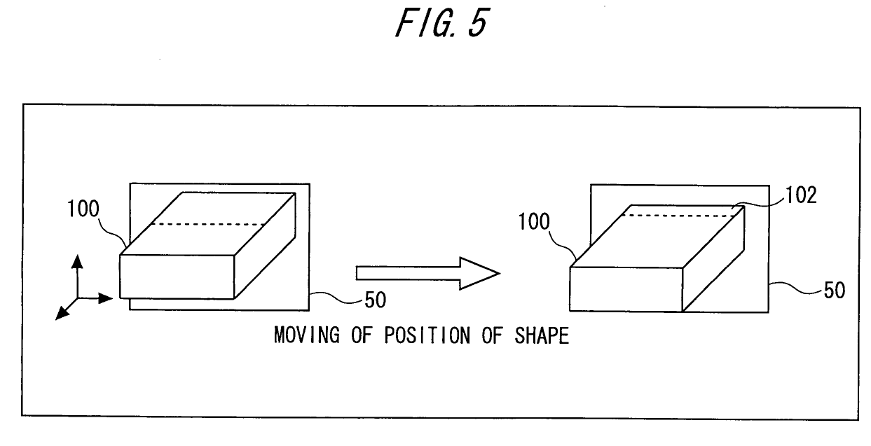

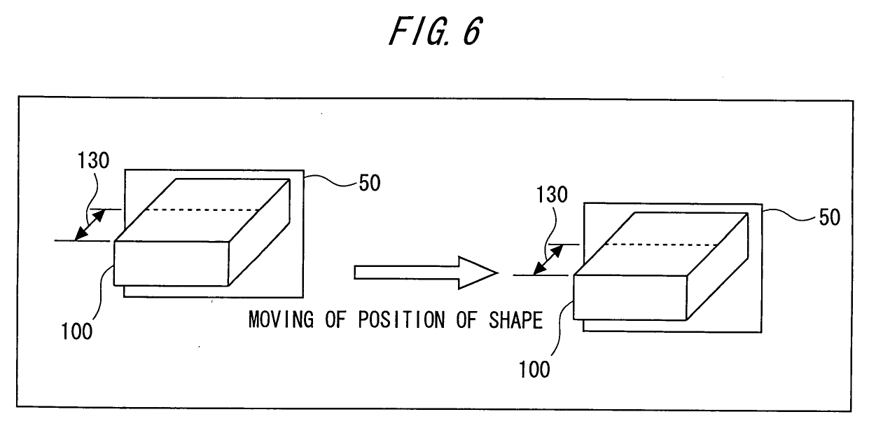

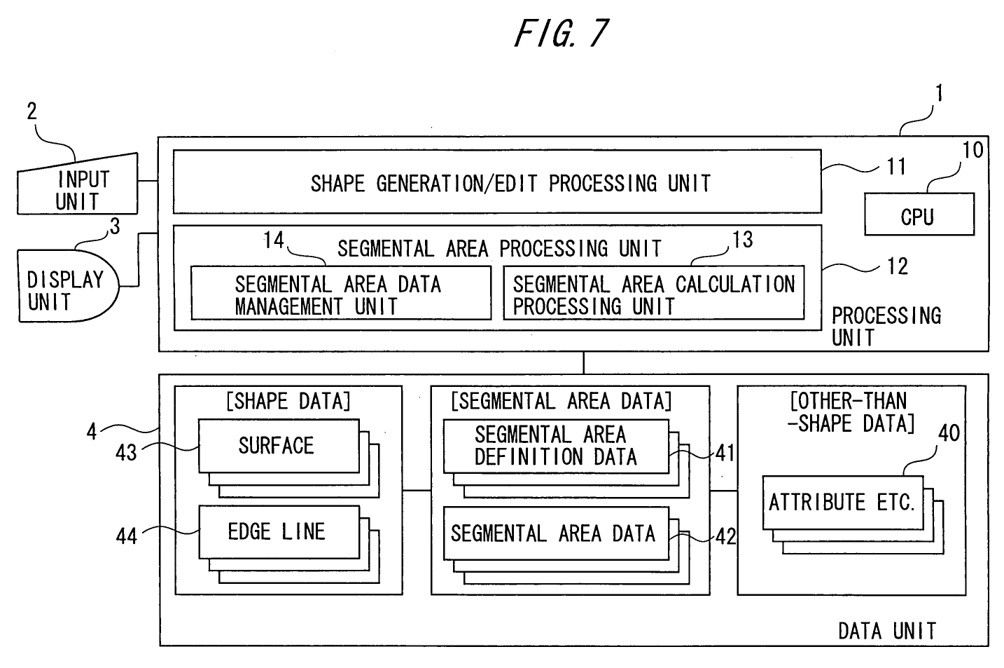

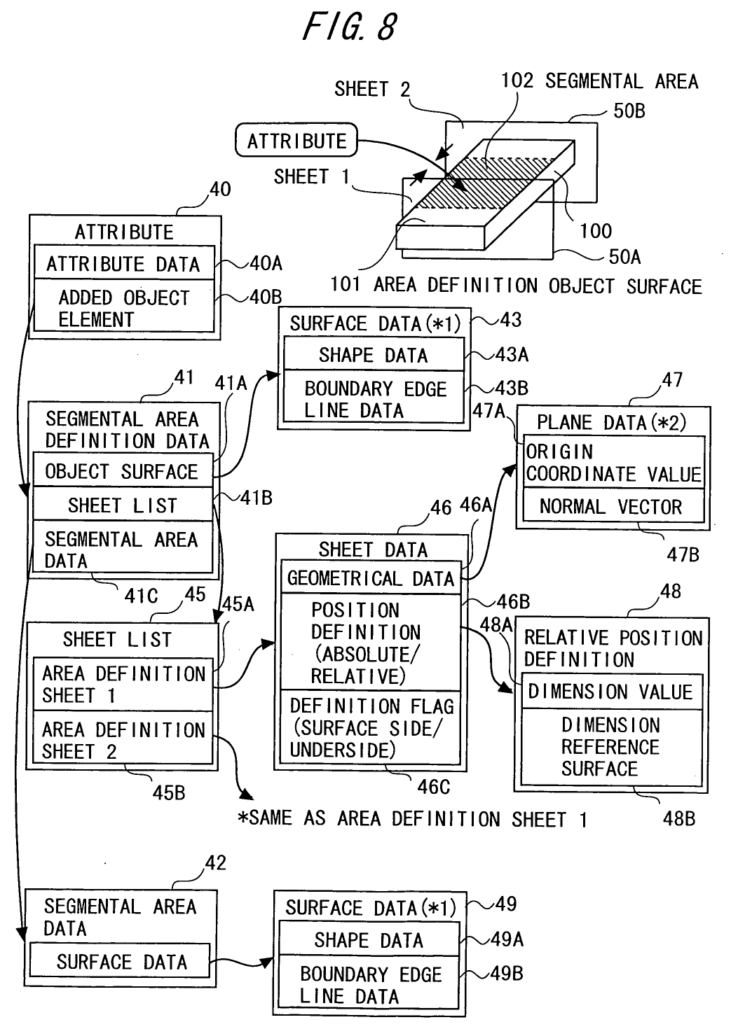

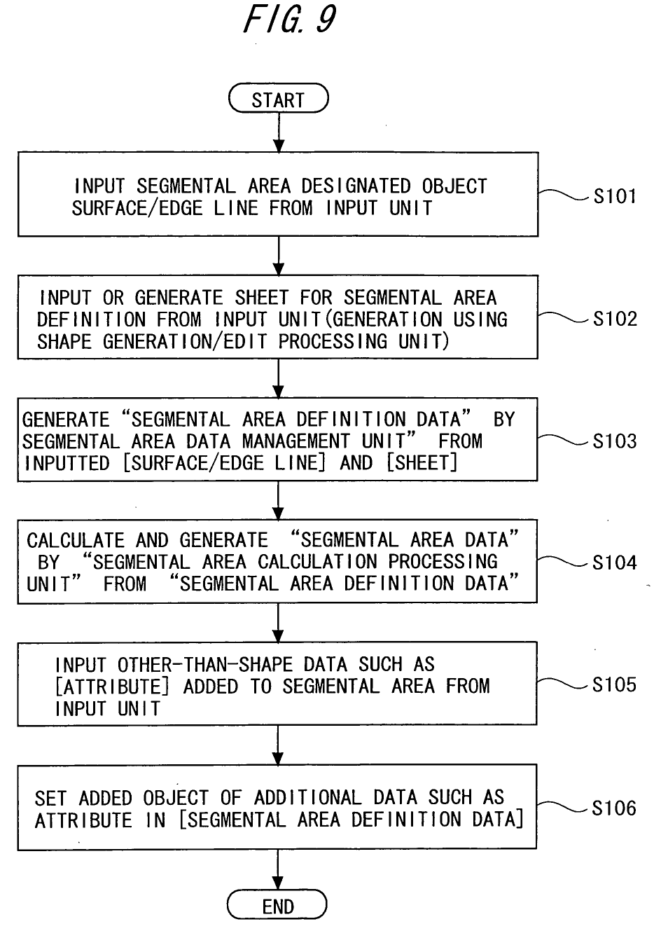

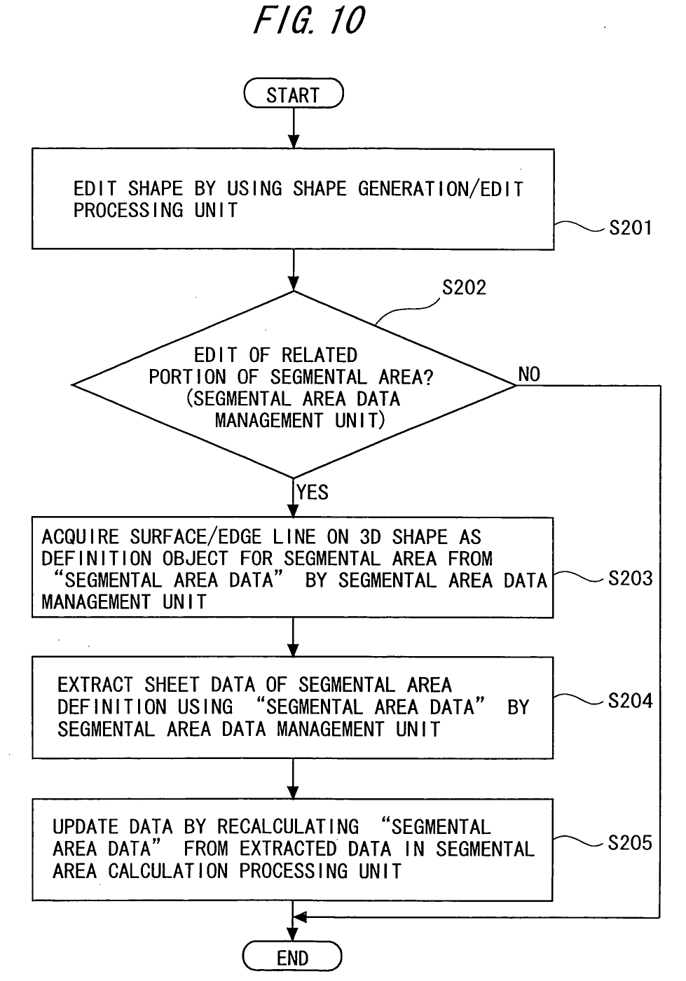

FIG. 3 is a view illustrating a concept of a segmental area in the present design supporting system. FIG. 4A-4C are views showing a definition example of the segmental area. FIG. 5 is a view showing a definition and an operation of an area definition sheet based on an absolute value definition (absolute coordinate system). FIG. 6 is a view showing a definition and an operation of the area definition sheet based on a relative value definition (relative coordinate system). FIG. 7 is a view of a system architecture of the present design supporting system. FIG. 8 is a diagram showing relationships between data structures of various categories of data and these items of data when defining the segmental area. FIG. 9 is a flowchart showing a processing sequence when defining the segmental area. FIG. 10 is a flowchart showing a recalculation process of the segmental area when editing a shape.

<Concepts of Segmental Area and Area Definition Sheet>

A feature of the present design supporting system lies in such a point that in the case of segmenting a three dimensional shape into segmental areas, three dimensional plane data called a area definition sheet is defined separately from and independently of this three dimensional shape. This area definition sheet is related to the three dimensional shape, however, none of information is added to the data of the three dimensional shape itself.

Namely, the present design supporting system provides a mechanism for storing the area definition sheet (a sheet train in the case of plural sheets) for defining the area in linkage with a three dimensional shape of a processing object. This mechanism provides a function capable of defining the segmental area on the three dimensional shape without editing the shape itself. This segmental area is defined by a processing object surface (to which attributes such as a processing method should be attached) or an edge line circumscribing this surface, intersecting portions with the area definition sheet train, and a direction of each of the area definition sheets (e.g., a direction of normal vector in an equation of the plane representing the sheet).

Further, the present design supporting system calculates the segmental area by computing the three dimensional shape data and the data of the area definition sheet (the calculation about the intersecting portion). Moreover, the present design supporting system adds pieces of attribute information such as a processing method and processing accuracy excluding the shape information to such a segmental area.

FIG. 3 is the view showing the concept of the segmental area. FIG. 3 illustrates a three dimensional shape 100 that is a rectangular parallelopiped as a processing object. Further, FIG. 3 shows an exemplification of how defining a segmental area 102 on a specified processing object surface (which will hereinafter be referred to as an area definition object surface 101) of this three dimensional shape 100.

Herein, the segmental area is an area defined on an area definition object surface 101 circumscribed by an edge line 110-112 of the three dimensional shape 100 and a boundary line 103.

The present design supporting system, in this case, sets an area definition sheet 50 as a plane passing through the boundary line 103. This area definition sheet 50 is specified in a so-called plane equation and has, e.g., a direction 51 toward the normal vector.

When setting this type of area definition sheet 50, the present design supporting system calculates the boundary line 103 as an intersecting portion from the three dimensional shape 100 and from data of the area definition sheet 50. Then, a segmental area 102 circumscribed by the edge line 110-112 and the boundary line 103 is established according to the direction 51 of the area definition sheet 50. Therefore, when pieces of other-than-shape information about attributes such as a processing condition, a processing method and processing accuracy are set together with the definition of the area definition sheet 50, the present design supporting system deems that these attributes are added (attached) to the segmental area 102, and displays the attributes when outputting, e.g., a drawing.

FIG. 4A-4C are views showing an example of the definition of the segmental area. In FIG. 4A, there is set a pair of area definition sheets 50A, 50B intersecting a three dimensional shape 120. At this time, the two area segment definition sheets 50A, 50B define the segmental area 102 on the sides opposite to each other by directions 51A, 51B. Thus, the segmental area may also be defined by a combination of a plurality of area definition sheets.

On the other hand, in FIG. 4B, area definition sheets 50C, 50D, which are so set as to intersect a three dimensional shape 121, set the segmental areas in positions directed opposite to each other as defined by directions 51C, 51D of these sheets. Namely, the two segmental areas are formed in the vicinities of two side portions of the area definition object surface 101. Thus, the plurality of segmental areas may be defined by the plurality of area definition sheets.

Further, in FIG. 4C, an area definition sheet 50E, which is so set as to intersect a three dimensional shape 122, has a plurality of surfaces (taking a crank-like 3-surface combined shape in FIG. 4C). The area definition sheet 50E formed of the plural surfaces can be equivalently constructed of a plurality of area definition sheets 50E1, 50E2 and 50E3.

<Coordinate System>

The area definition sheet described above is defined by, e.g., the normal vectors that specify the plane, reference points (which are basically elements structuring the plane equation). The data specifying this type of area definition sheet contains coordinates that can be defined in an absolute coordinate system or a relative coordinate system.

The absolute coordinate system is a coordinate system where the reference point is an origin within a three dimensional space. Further, the relative coordinate system is a coordinate system where the reference point is one point on the three dimensional shape of the processing object.

FIG. 5 is a view showing a definition and an operation of the area definition sheet according to the absolute value definition (the absolute coordinate system). FIG. 5 shows a processing example in such a case that coordinate values of the area definition sheet 50 are defined by values (absolute values) in the absolute coordinate system, and a position of the three dimensional shape 100 is moved by changing the design, and so on. In this case, even when the position of the three dimensional shape 100 is moved, the position of the area definition sheet 50 remains unchanged. Accordingly, the segmental area 102 is defined in a state where the position of the area definition sheet 50 is fixed. This type of segmental area definition is effective in, for example, designating the attributes such as specified finishing in a contact range with other components when assembling the components.

FIG. 6 is a view showing a definition and an operation of the area definition sheet according to the relative value definition (the relative coordinate system). In the relative coordinate system, the coordinate values of the area definition sheet 50 are defined by relative values to the three dimensional shape 100. Then, when the position of the three dimensional shape 100 is moved due to the change in design etc., the position of the area definition sheet 50 changes in a way that follows the three dimensional shape 100. Accordingly, before and after the change in position etc., the segmental area on the processing object is maintained. For instance, a width 130 etc. of the segmental area is maintained. Such a definition of the segmental area is effective in, e.g., a case of adding a finishing attribute to only a fixed range from the front end of the component.

<System Architecture>

FIG. 7 is a diagram of the system architecture of the present design supporting system. The present design supporting system is constructed by employing computers such as a personal computer (PC), a workstation (WS) and a dedicated server machine in order to execute the processes related to the present invention. This design supporting system includes, as pieces of unillustrated hardware, a processing device (constructed of a CPU, a main storage device (RAM etc. ), an input/output unit, a device driver, etc. ), an input device (a keyboard, a mouse, etc.), a display device (a display device, a printer, a plotter, etc.) and a secondary storage device (a hard disc etc.). Then, the present design supporting system actualizes a processing unit 1, an input unit 2, a display unit 3 and a data unit 4 as functions for executing the processes related to the present design supporting system.

The processing unit 1 executes the existing three dimensional design supporting process together with the segmental area related processes such as the generating process, the editing process and arithmetic process about the segmental area according to the present design supporting system. The processing unit 1 includes a CPU 10, a shape generation/edit processing unit 11, a segmental area processing unit 12, a segmental area calculation processing unit 13 and a segmental area data management unit 14.

The CPU 10 loads the programs stored on the secondary storage device into the main storage device and executes the programs, thereby actualizing the shape generation/edit processing unit 11, the segmental area processing unit 12, the segmental area calculation processing unit 13 and the segmental area data management unit 14.

The shape generation/edit processing unit 11 generates information of a shape of the design-supported three dimensional shape 100. Further, the shape generation/edit processing unit 11 executes the editing process such as changing the shape of the three dimensional shape 100.

The segmental area processing unit 12 executes the process related to the segmental area according to the present design supporting system. The segmental area processing unit 12 includes the segmental area calculation processing unit 13 and the segmental area data management unit 14 in order to execute the process about this segmental area.

The segmental area calculation processing unit 13 executes the arithmetic process such as a segmental area coordinate value arithmetic (computing) process, which occurs for the three dimensional shape 100 due to the generation of the segmental area according to the present design supporting system.

The segmental area data management unit 14 temporarily stores (caches) and manages various categories of segmental area related data such as the data of the coordinate values of the segmental area and the data of the normal vectors.

The input unit 2 corresponds to the hardware input device. The input unit 2 is exemplified by, e.g., a keyboard and a pointing device such as a mouse, a pen tablet and a touch panel. Then, the input unit 2 accepts, according to the present design supporting system, instructions of the processes of generating and editing the three dimensional shape 100 and the area definition sheet 50 or accepts inputs of numerical values and characters.

The display unit 3 corresponds to the hardware output device. The display unit 3 is exemplified by, e.g., s display device such as a CRT and a liquid crystal display or by a printing device such as a printer and a plotter. Then, the display unit 3 displays the three dimensional shape 100 and the area definition sheet 50 according to the present design supporting system.

The data unit 4 is actualized by the hardware secondary storage device. The data unit 4 is stored with other-than-shape data like attribute data 40, segmental area data such as segmental area definition data 41 and segmental area data 42, and segment area related shape data such as three dimensional shape element surface data 43 and three dimensional shape element edge line data 44. It is to be noted that structures of the respective categories of data stored on the data unit 4 will be explained in detail in the following item.

<Data Structure>

FIG. 8 is the diagram showing the relationships between the data structures of various categories of data and these items of data when defining the segmental area. As shown in FIG. 8, the present design supporting system, when defining the segmental area, stores the attribute 40, the segmental area definition data 41, the segmental area data 42, the surface data 43, segmental area surface data 49, a sheet list 45, sheet data 46, plane data 47 and a relative position definition 48 in a way that associates these items of data with each other. FIG. 8 exemplifies the data structure in the case of setting area definition sheets 50A, 50B that intersect the three dimensional shape 100.

In the present design supporting system, the attribute 40 represents attributes such as the processing condition, the processing method and the processing accuracy, which are set in the segmental area 102 of the three dimensional shape 100.

The attribute 40 contains attribute data 40a designating the attribute and an added object element 40B indicating an object to which the attribute is attached.

The attribute data 40A is a character string, a numerical value, a flag (information showing existence or non-existence (of the attribute)), etc., which specify the attribute. Further, the added object element 40B is a link to the segmental area definition data 41 that defines the object (the segmental area) to which the attribute is attached. For example, a pointer to the segmental area definition data 41 may be retained as this type of link. Moreover, a name of tags containing the segmental area definition data 41 may also be retained for data as in XML (extensible Markup Language). Furthermore, a piece of identifying information is attached to the three dimensional shape in a general-purpose three dimensional CAD and in a dedicated format for every CAD maker, and this identifying information may also be retained. This is the same with other links.

The segmental area definition data 41 defines the object to which the attribute 40 is attached. The segmental area definition data 41 contains an object surface 41A, a sheet list 41B and a segmental area definition data 41C.

Designated in the object surface 41A is an object surface (to which the attribute is attached in the three dimensional shape 100 of the processing object) on which the segmental area is defined. For instance, a link to the surface data 43 that defines the object surface may be stored in the object surface 41A.

Further, a link to the sheet list 45 showing a combination of sheets that define the segmental area is stored in the sheet list 41B. Moreover, a link to the segmental area 102 calculated from the area definition sheet 50 and from the three dimensional shape 100 is stored in the segmental area definition data 41C.

The surface data 43 is data defining the surfaces forming the three dimensional shape 100 of the processing object and is data edited in a general type of three dimensional design system. The surface data 43 is stored by employing information of a three dimensional boundary representation method such as B-rep (Boundary-representation) on the computer. In the embodiment, the surface data 43 contains shape data 43A and boundary edge line data 43B as the data used for the boundary representation.

Further, a link to the segmental area data 42 generated when the segmental area is defined by the area definition sheet 50, may be stored in the segmental area definition data 41C.

Stored in the segmental area data 42 is a link to the data calculated and generated according to the necessity if a change occurs in the data related to the segmental area such as when defining the segmental area and when editing the shape thereof. This segmental area data 42 is generated from arithmetic operations, e.g., between the area definition object surface 101 and the area definitions sheets 50A, 50B. A link to the segmental area surface data 49 is stored in this segmental area data 42.

The segmental area surface data 49 is stored with the same data as the surface data 43 about the surfaces that specify the three dimensional shape. Namely, the segmental area surface data 49 is stored with the information used for the boundary representation of the segmental area. In the embodiment, the segmental area surface data 49 contains shape data 49A and boundary edge line data 49B as pieces of data employed for the boundary representation.

The sheet list 45 contains data 45A of the area definition sheet 50A and data 45B of the area definition sheet 50B. A link to the sheet data 46 is stored in each of the data 45A and the data 45B for the respective area definition sheets. Note that contents of the data linking from the data 45A and the data 45B for the area definition sheets are common throughout all the area definition sheets to be defined. Hence, explanations of the sheet data 46, the plane data 47 and the relative position definition 48 will hereinafter be made with respect to the area definition sheet 50A.

The sheet data 46 is stored with links to such items of data as a coordinate value, a vector value and a dimension values that are required to define the area definition sheet 50A. The sheet data 46 contains geometrical data 46A, an (absolute/relative) position definition 46B and a (surface side/underside) definition area flag 46C.

The geometrical data 46A is stored with a coordinate value and vector information of a shape of the area definition sheet 50A. The geometrical data 46A has a link to the plane data 47 in order to store the data about the shape of the area definition sheet 50A. It should be noted that the geometrical data 46A has the link to the data corresponding to the shape of the area definition sheet 50A. Therefore, if the three dimensional shape 100 as the (definition) object of the area definition sheet 50A is not plane, the geometrical data 46A has links to other categories of data in place of the plane data 47. For example, if the three dimensional shape 100 is a curved surface such as a cylindrical surface, the geometrical data 46A has a link to curved surface data.

The plane data 47 is stored with, as data about the shape of the area definition sheet 50A, an origin coordinate value 47A of the sheet 50A and information on the normal vector 47B held by the sheet 50A.

The (relative/absolute) position definition 46B is stored with a link to information necessary for determining relative coordinates of the area definition sheet 50A and a position on the absolute coordinates, e.g., a link to the relative position definition 48.

The relative position definition 48 is information defined for the area definition sheet 50A in the case of only the relative coordinate system. The relative position definition 48 has pieces of information about a dimension value 48A of the area definition sheet 50A and a dimension reference surface 48B serving as the reference for taking dimensions of the sheet 50A.

The definition area flag 46C is a flag for determining which area corresponds, based on the area definition sheet 50A, to the segmental area defined by this area definition sheet 50A.

Note that data-to-data linking arrowheads in FIG. 8 have been explained as the links in the embodiment, however, the data of the link destination may also be captured (stored) directly in the link source. The surface data 43 and the segmental area definition data 41 are, however, associated with each other through the object surface 41A. With this contrivance, even when adding the area definition sheets 50A and 50B, the surface data 43, i.e., the three dimensional shape 100 is not directly changed.

<Processing Flow>

FIG. 9 is the flowchart showing a processing procedure when defining the segmental area.

At first, the user inputs the object surface or the object edge line for designating the segmental area to be displayed on the display unit 3 from the input unit 2 of the present design supporting system (step 101, which will hereinafter be abbreviated such as S101). The thus-inputted surface or edge line is, e.g., the boundary line 103 or the edge line 110-112 of the three dimensional shape 100 in FIG. 3.

The sheet for defining the segmental area is inputted to a position of the surface or the edge line from the input unit 2, whereby the sheet is generated for the three dimensional shape in the present design supporting system (S102). This sheet is, for example, the area definition sheet 50 in FIG. 3.

Next, in the present design supporting system, the segmental area data management unit 14 of the processing unit 1 generates, from the inputted surface or the inputted edge line 110-112 and the area definition sheet 50, the segmental area definition data 41 as the data that defines the area definition object surface 101 serving as the object on which to generate the segmental area 102 on the three dimensional shape 100 (S103).

In the present design supporting system, the segmental area calculation processing unit 13 calculates and generates, from the segmental area definition data 41, the segmental area data 42 as the data that defines the segmental area 102 on the area definition object surface 101 (S104).

After processing in S104, the three dimensional shape 100 with the segmental area 102 defined as shown in FIG. 3 is displayed on the display unit 3. In the present design supporting system, the other-than-shape data such as the attribute data 40 attached to this segmental area 102 is inputted from the input unit 2 (S105). This other-than-shape data is exemplified by, e.g., a roughness indicating code of the surface finishing for the surface becoming this segmental area 102.

Then, in the present design supporting system, the object to which the additional data of the other-than-shape data such as the attribution data 40 is attached, is set in the segmental area 102 by use of the segmental area definition data 41 (S106). With this setting, the other-than-shape data such as the attribution data 40 can be associated (attached) without dividing the segmental area 102 as the specified area on the area definition object surface 102 of this three dimensional shape 100.

FIG. 10 is a flowchart showing a recalculation process of the segmental area when editing the shape.

To begin with, in the present design supporting system, the shape generation/edit processing unit 11 edits a shape of the three dimensional shape 100 (step 201, which will hereinafter be abbreviated to such as S201 in FIG. 10).

Next, the segmental area data management unit 14 judges whether or not the edited portion of this shape is subjected to the editing of a related portion that defines the segmental area (S202). For example, in FIG. 3, it is judged whether the area definition object surface 101 related to the segmental area 102 is edited or not. In S202, if judged not to be the editing about the area definition object surface 101, this process is finished.

In S202, if judged to be the editing about the area definition object surface 101, the segmental area data management unit 14 acquires, from the segmental area data, the information about the surface 101 or the edge line 110-112 on the three dimensional shape 100, which becomes the segmental area definition object (S203).

Then, the segmental area data management unit 14 extracts the data of the area definition sheet 50 by use of the segmental area data of the segmental area 102 subjected to this editing (S204).

The segmental area calculation processing unit 13 recalculates the segmental area data from the extracted data of the area definition sheet 50, and may update the data of the area definition sheet 50 and the data of the segmental area 102 after the editing (S205). Thus, according to this process, in the case of defining the segmental area on the specified object surface on the three dimensional shape, there is eliminated the necessity of individually editing each individual segmental area when the shape editing occurs.

<Effect of Embodiment>

As discussed above, in the present design supporting system, in the case of attaching the attributes such as the processing method to the segmental area of the three-dimensional shape data, the segmental area is defined by the area definition sheet intersecting the three dimensional shape. This area definition sheet is stored separately from and independently of the three dimensional shape data as the object to which the attributes are attached. Then, as shown in FIG. 8, the attribute data, the sheet data and the three dimensional shape data (surface data) are associated with each other (linked to each other).

Therefore, the three dimensional shape data can be segmented into the segmental areas without changing the three dimensional shape data itself. Further, the various items of attribute information such as the processing method and the processing accuracy can be thus attached to the segmental area.

Hence, as by the conventional method, the unrequired edge lines and points and unnecessary pieces of other information are not added to the three dimensional shape data, for example, in the case of calculating an a real size, there is no difficulty of acquiring the data depending on the shape, such as counting the number of surfaces and the number of line segments.

Moreover, in the present design supporting system, the area definition sheet can be defined by the relative coordinate system with respect to the three dimensional shape data of the processing object or by the absolute coordinate system together with the three dimensional shape data of the processing object.

When the area definition sheet is defined by the absolute coordinate system as shown in FIG. 5, for instance, also in such a case that the position of the three dimensional shape (a three dimensional model such as a rectangular parallelopiped) is moved because of a change in design etc., the area definition sheet remains unmoved. It is therefore possible to define the segmental area in which the reference position is the position of the area definition sheet and in which the absolute coordinate of one side of the segmental area is fixed.

Furthermore, in the case of defining the area definition sheet by the relative coordinate system as depicted in FIG. 6, when the position of the three dimensional shape (the three dimensional model such as the rectangular parallelopiped) is moved because of the change in design etc., the position of the area definition sheet likewise changes. Hence, it is feasible to define the segmental area in which the shape, the dimensions, etc. of the segmental area are maintained on the three dimensional shape of the processing object.

<Modified Example>

It should be noted that the program and the design supporting device of the present invention are not limited to the present embodiment, and can be, as a matter of course, changed in many forms within the scope that does not deviate from the gist of the present invention.

For example, in the present embodiment, the present invention is applied to the design supporting system using the segmental area but is not limited to this system. Namely, the present invention can be applied to other systems, devices and application programs in addition to the design supporting system that defines the segmental area on the three dimensional shape and attaches the additional information to the segmental area.

### INDUSTRIAL APPLICABILITY

As explained so far, the present invention can be applied to an industry for providing such a design supporting technology that the segmental area is defined on the three dimensional shape without exerting influence on the shape information for defining the three dimensional shape, and the attributes are set in the segmental area.

What is claimed is:

1. A three dimensional shape design supporting program making a computer execute:
a step editing three dimensional shape information that defines a three dimensional shape containing one or more surfaces; and
a sheet setting step setting sheet information of a three dimensional sheet intersecting the three dimensional shape and segmenting any one of the surfaces into a segmental area(s).

2. The program according to claim 1, further comprising a step storing the sheet information independently of the three dimensional shape information.

3. The program according to claim 1, further comprising a step adding attribute information other than the shape related information to the segmental area.

4. The program according to claim 3, further comprising:
a step storing the attribute information independently of the three dimensional shape information; and
a step storing information that associates the attribute information, the sheet information and the three dimensional shape information with each other.

5. The program according to claim 3, wherein the attribute information contains information related to processing of the three dimensional shape.

6. The program according to claim 1, wherein the sheet setting step includes defining the sheet information by a relative coordinate system to the three dimensional shape information.

7. The program according to claim 1, wherein the sheet setting step includes defining the sheet information by an absolute coordinate system including the three dimensional shape information.

8. The three dimensional design supporting program making a computer execute:
a step defining a three dimensional graphic form and storing information that defines the three dimensional graphic form in accordance with an operation of an operator;
a step storing information that defines a sheet as a surface defined independently of the three dimensional graphic form in accordance with the operation of the operator in a way that associates this sheet defining information with a surface(s) shaping the three dimensional graphic form;
a step generating and storing information defining a segmental area of the surface shaping the three dimensional graphic form on the basis of the information defining the three dimensional graphic form and the information defining the sheet; and
a step regenerating and storing, as a trigger of a change in the information of the three dimensional graphic form or in the information of the sheet, the information defining the segmental area on the basis of the information after being changed.

9. The three dimensional design supporting apparatus comprising:
a module editing a three dimensional shape containing one or more surfaces; and
a module setting sheet information of a three dimensional sheet intersecting the three dimensional shape and segmenting any one of the surfaces into a segmental area(s).

10. The three dimensional design supporting apparatus according to claim 9, further comprising a module storing the sheet information independently of the three dimensional shape information.

11. The three dimensional design supporting apparatus according to claim 9, further comprising a module adding attribute information other than the shape related information to the segmental area.

12. The three dimensional design supporting apparatus according to claim 11, further comprising:
a module storing the attribute information independently of the three dimensional shape information; and
a module storing information that associates the attribute information, the sheet information and the three dimensional shape information with each other.

13. The three dimensional design supporting apparatus according to claim 11, wherein the attribute information contains information related to processing of the three dimensional shape.

14. The three dimensional design supporting apparatus according to claim 9, wherein the module setting the sheet information defines the sheet information by a relative coordinate system to the three dimensional shape information.

15. The three dimensional design supporting apparatus according to claim 9, wherein the module setting the sheet information defines the sheet information by an absolute coordinate system including the three dimensional shape information.
